(19) United States
(12) Patent Application Publication
(10) Pub. No.: US 2010/0098959 A1
(43) Pub. Date: Apr. 22, 2010

(54) COMPOSITIONS BASED ON CARBOXYLIC ACIDS FOR TEMPORARY PROTECTION OF METALLIC SURFACES AND DRY FILMS OBTAINED FROM SAID COMPOSITION

(75) Inventors: Nicole Genet, Villeurbanne (FR); Olivier Lerasle, Lyon (FR); Thierry Kouvtanovitch, Montmorency (FR)

Correspondence Address: HARNESS, DICKEY & PIERCE, P.L.C., P.O. BOX 828, BLOOMFIELD HILLS, MI, 48303, US

(73) Assignee: Total Raffinage Marketing, Puteaux (FR)

(21) Appl. No.: 12/376,481

(22) PCT Filed: Jun. 21, 2007
(86) PCT No.: PCT/FR2007/001028

§ 371 Date: Sep. 1, 2009

(30) Foreign Application Priority Data
Aug. 8, 2006 (FR) 0607225

(51) Int. Cl. B32B 15/04; C09D 4/00

(52) U.S. Cl. 428/467; 106/14.35

(57) ABSTRACT

The invention relates to a composition based on carboxylic acids and on at least one neutralizing agent, characterized in that the composition comprises a eutectic mixture of at least two carboxylic acids containing n carbon atoms, where 6≦n≦22. Application to the temporary protection of metallic surfaces, and dry films obtained from the said compositions.

### CROSS-REFERENCE TO RELATED APPLICATIONS

This application is a National Phase Entry of International Application No. PCT/FR2007/001028, filed Jun. 21, 2007, claiming priority to French Patent Application No. 06/07225, filed Aug. 8, 2006, both of which are incorporated by reference herein.

### BACKGROUND AND SUMMARY

The present invention relates to a composition for protecting metallic surfaces sensitive to atmospheric oxidation, based on carboxylic acids and on at least one neutralizing agent. It also relates to the method for depositing said composition on these surfaces as well as to its use for protecting various specific metallic surfaces.

After forming metallic plates and/or tubes, it is frequent to store them for long months under shelter before using them. This storage has large drawbacks for the manufacturers because of the gradual deterioration of the surface condition of these metallic parts. Indeed, in the absence of protection against oxidation from air and from moisture, an oxidation layer or pitting phenomena . . . are formed at the surface of these materials.

Now, any alteration of the surface of these materials may interfere with their application, by for example increasing the risks of failures or cracks during the forming or die-stamping step. Further, this deterioration may considerably affect effectiveness of subsequent treatments which metallic surfaces undergo. Indeed, flaking or cracking phenomena of the coatings with which they are covered, are observed.

In order to avoid these drawbacks related to oxidation in air, it is necessary to isolate these metallic supports, plates or tubes, from air and several techniques have already been used for this. Indeed, different types of temporary airproof coatings have been developed. In addition to their temporary character, these coatings should be easy to apply, but should also be easily removed without producing additional pollution, change of the surface condition of the support or trouble during their handling.

A first type of coating usually used consists of oily or semi-oily compositions obtained by mixing water and mineral oil in an emulsion in the presence of a corrosion inhibitor like in U.S. Pat. No. 4,342,596. Another type of oily coating comprises an emulsified mixture in water of paraffins and of partially esterified paraffins, of a small proportion of amides resulting from the reaction of an amine on a long chain carboxylic acid, of a mixture of alcohol, hydrocarbons and surfactant as described in U.S. Pat. No. 4,479,981. Such coatings are shown to have good stability and form a good barrier to atmospheric oxidation. In addition, they play a lubricating role during subsequent treatments of the thereby protected materials. However, for simple storage, the oiliness of these coatings is a nuisance and a non-negligible source of pollution.

Moreover, the applicant proposed in her patent application EP 1 082 392, a composition comprising a combination of at least two linear carboxylic acids with an odd carbon chain (from 5 to 21 carbon atoms), one being saturated and the other being unsaturated. The composition described in this application is quite effective. Nevertheless, there is always a need in the art for improving in the dry film the effectiveness of the protection against corrosion of metallic surfaces.

The applicant proposes providing a technical solution with which an improved coating may be obtained for protecting metallic surfaces from atmospheric corrosion as a non-oily dry film. Thus, the handling of these surfaces is facilitated and the risks of pollution of the storage premises are limited. For this purpose, the invention proposes a composition for protecting metallic surfaces sensitive to atmospheric oxidation, based on carboxylic acids and on at least one neutralizing agent, characterized in that the composition comprises an eutectic mixture of at least two carboxylic acids comprising n carbon atoms, with 6≦n≦22. For this purpose, the object of the invention is also a method for applying this composition on metallic objects having metallic surfaces, as well as the thereby obtained dry film and the metallic objects coated with this dry film. The dry film is obtained by evaporation of the solvent, generally water, which the composition according to the invention contains. The invention is therefore directed at the dry film obtained by evaporation of the composition according to the invention.

The invention has several advantages, including significant improvement of anticorrosion properties. Thus, it is possible to attain the same anticorrosion protection effectiveness by applying an amount of the composition according to the invention, which is less significant than that of a composition of the prior art, based on carboxylic acids and on a neutralizing agent. Moreover, for a same amount of composition used, protection against corrosion is higher in the case of the composition according to the invention.

As this protective solution is water-soluble, it becomes possible although non-mandatory, to do without organic co-solvent. The object of the invention is therefore also a composition characterized in that it contains water as a single solvent. The pH is generally comprised between 6 and 9, and preferentially between 7 and 9, advantageously between 7 and 8. With such a pH, notably a basic one, thin and ultra-thin films of the order of a few molecular layers may be obtained. The thickness of the thin films is typically less than one micron, and for example between 1 and 500 nm.

Further, once the dry film is obtained, it may then be easily removed by washing with water and by drying. The latter may also remain on the metallic surface under a subsequent coating, because for certain paints and certain varnishes, the presence of the dry film improves adherence of the subsequent layers. Moreover, the lubricating properties of these coatings according to the invention are excellent. With them it is i.a. possible to do without oiling by polluting mineral oils, of the coated product during its shaping.

Advantageously, the composition according to the invention comprises an eutectic mixture of at least two carboxylic acids comprising n carbon atoms, n being preferentially even. Thus, the fatty acids which may be used in the context of the invention may originate from green sector products, i.e. from agricultural production, particularly for non-food use (sunflower, flax, rapeseed oils . . . ). They advantageously replace polluting mineral oils used for lubricating metallic surfaces. According to a preferred embodiment of the invention, n is larger than or equal to 10. According to another embodiment, n is less than or equal to 18.

According to a first preferred embodiment of the invention, the eutectic mixture is a mixture of two carboxylic acids, the first comprising from 10 to 16 carbon atoms, and the second from 14 to 22 carbon atoms. The respective mass proportions of said acids advantageously are x±5%-y±5%, x and y being the respective mass proportions of both acids in said binary mixture with the exact composition of the eutectic. According to an embodiment, the difference between each value of n for each of both acids ranges from 2 to 10.

According to a second embodiment of the invention, the eutectic mixture is a mixture of three carboxylic acids comprising from 10 to 16 carbon atoms for the first, from 14 to 18 for the second, and from 16 to 22 for the third carboxylic acid. The respective mass proportions of said acids are x±3%-y±3%-z±3% for a ternary mixture, x, y and z, being the respective mass proportions of the three acids in a mixture with the exact composition of the eutectic. The protective composition according to the invention may advantageously contain from 0.5 to 5% by weight of at least one anticorrosion agent. The selection of the latter is carried out depending on the neutralization method used and may prove to be important such as for example when neutralization is carried out by adding soda. Said anticorrosion agent may be selected from derivatives of triazole, such as benzotriazole and tolyl triazole, derivatives of imidazole such as benzimidazole, derivatives of citric acid or sorbic acid, and mixtures thereof.

The carboxylic acids suitable for the invention may be mono-, di- or tri-acids, in a linear or branched form, saturated or containing one or more unsaturations. Among them, those containing an even number of carbon atoms are preferred. Mention may be made as saturated even fatty acids of capric acid HC₁₀, lauric acid HC₁₂, myristic acid HC₁₄, palmitic acid HC₁₆, stearic acid HC₁₈, arachidic acid HC₂₀, and behenic acid HC₂₂. Mention may also be made as unsaturated even fatty acids of palmitoleic acid HC₁₆:1 (i.e. containing a single unsaturation), oleic acid HC₁₈:1, gadoleic acid HC₂₀:1, and erucic acid HC₂₂:1. The fatty acids containing an odd number of carbon atoms are perfectly suited for producing the composition according to the invention. Among them, mention may be made of heptanoic acid HC₇, nonanoic acid HC₉, and undecylenic acid HC₁₁:1. According to an embodiment, in the composition, at least one of the acids is of vegetable origin.

The neutralizing agent, the function of which is notably to buffer the protective composition by varying the pH of the latter between 6 and 9, preferentially between 7 and 9, advantageously between 7 and 8, may be selected from those conventionally used by one skilled in the art. Among the latter, mention may be made of alkaline or earth alkaline metal hydroxides, including sodium, potassium, calcium or magnesium hydroxides, amino-alcohols, cyclic amines, either aromatic or not, acyclic, alicyclic, heterocyclic amines, primary, secondary or tertiary amines, notably alkylamines, imides and imines, and mixtures thereof. Sodium hydroxide NaOH, potassium hydroxide KOH, primary, secondary or tertiary amines are preferred.

According to another embodiment, the protective composition according to the invention may comprise at least one surfactant and/or at least one dispersant, said surfactant being selectable from alkylpolyglycosides, ethoxylated fatty alcohols, ethoxylated fatty acids, ethoxylated oils, ethoxylated sorbitan esters, and said dispersant being selected from polyols with high molecular weight, salts of carboxylic acids such as (meth)acrylic copolymers, derivatives of polyamides such as waxes of polyamides. The composition for protecting metallic surfaces according to the invention may further contain one or more additives, which one skilled in the art will easily be able to select from the numerous additives conventionally used. Let us notably mention, but in a non-limiting way, antifoam additives, bactericides, dyes, odor-masking agents, and mixtures thereof.

The invention is also directed to the method for treating metallic objects having a metallic surface comprising at least one step for applying the composition according to the invention on a metallic surface advantageously selected from zinc, iron, aluminum, copper, lead, and their alloys, as well as steels, galvanized, aluminated, coppered steels, the application step being performed by sprinkling, spraying or immersion. The selection of the concentration and of the amount of protective composition to be applied according to the treatment method of the invention will depend on the desired protection level, on the nature of the treated metallic surface and on its environment. Generally, the latter is prepared by diluting a concentrated composition (between 100-500 g/L of active material), up to a concentration which may be comprised before its application, between 1-50 g/L. The object of the invention is therefore also a composition in which the acid concentration is comprised between 1 and 500 g/I of active material, expressed as the total amount of carboxylic acid, preferably between 100 and 500 g/I of active material (concentrated solution) or between 1 and 50 g/L of active material (diluted solution).

Another object of the invention is the metallic surface treated with a composition according to the invention, and more advantageously the metallic surface covered with a dry film based on one of these compositions. The invention is also directed to a method for making a composition according to any of the preceding claims, by mixing its constituents, optionally with heating. With the mixing step, acids may be put into solution in the solvent most often exclusively consisting of water.

The object of the invention is further a method for washing coated objects according to the invention, in order to obtain objects with a clean and non-oxidized surface. The object of the invention is further a method for shaping coated objects according to the invention. The object of the invention is further a method for painting or varnishing coated objects according to the invention.

### BRIEF DESCRIPTION OF DRAWINGS

The invention will be better understood upon reading the detailed description with reference to the appended figures wherein

FIG. 1 illustrates the change in the response current depending on the corrosion potential for protective solutions based on HC₇/HC₁₁:1 from the prior art (-⋄-) and based on a binary eutectic mixture HC₁₂/HC₁₆ ( [symbol] ) according to the invention.

FIG. 2 illustrates the change in the response current depending on the corrosion potential for protective solutions based on HC₇/HC₁₁:1 from the prior art (-⋄-), on a binary eutectic mixture HC₁₂/HC₁₆ ( [symbol] ) and on a ternary eutectic mixture HC₁₂/HC₁₆/HC₁₈ (-Δ-) according to the invention.

FIG. 3 illustrates the change in the response current depending on the corrosion potential on carbon steel at 25° C. for protective solutions based on HC₇/HC₁₁:1 from the prior art (-⋄-), on a binary eutectic mixture C12/C16 ( [symbol] ) and on a ternary eutectic mixture HC₁₂/HC₁₆/HC₂₂:1 (-Δ-) according to the invention.

FIG. 4 illustrates the change in the response current depending on the corrosion potential on carbon steel at 25° C. for protective solutions based on HC₇/HC₁₁:1 from the prior art (-⋄-), on a binary eutectic mixture C₁₂/C₁₆( [symbol] ) on a ternary eutectic mixture HC₁₂/HC₁₆/HC₂₂:1 neutralized with TriEthanolAmine (TEA) (-Δ-) and on a ternary eutectic mixture HC₁₂/HC₁₆/HC₂₂:1 neutralized with a TEA/DiGlycolAmine(DGA) mixture ( [symbol] ) according to the invention.

FIG. 5 illustrates the change in the response current depending on the corrosion potential on galvanized steel at 25° C. for protective solutions based on HC₇/HC₁₁:1 from the prior art (-⋄-) and on a ternary eutectic mixture HC₁₂/HC₁₆/HC₂₂:1 neutralized with TEA/DGA mixture ( [symbol] ) according to the invention.

### DETAILED DESCRIPTION

It should be understood that in the present application, the term “eutectic” designates a mixture having a eutectic behavior containing at least two carboxylic acids, the eutectic behavior being expressed by the fact that the mixture has a single melting point, less than the melting point of each of the carboxylic acids taken separately. The term “exact composition of the eutectic” targets the composition which corresponds in the phase diagram, to where the liquidus has a minimum which touches the solidus.

### Examples

The following examples illustrate the invention and its advantages without however limiting its scope.

Principle of the Conducted Tests.

The inhibitory potential of the different protective compositions is determined by standardized electrochemical measurements, based on ISO 17475, on samples of common carbon steel, electro-galvanized steel and galvanized steel. The experimental cell consists of a glass thermostated chamber and of three electrodes:
an electrode formed by the steel sample, which is the working electrode undergoing corrosion,
a saturated calomel reference electrode used for measuring the potential,
and a auxiliary platinum electrode, used for measuring the current.
   The steel sample has a circular surface of 43 cm² in contact with an aqueous solution obtained by diluting the concentrated mixture of neutralized carboxylic acids according to the prior art or according to the invention, in the corrosive water of type ASTM D 1384. Thus, a sweep in potential of the sample (representative of the aggressivity of the medium) is performed and the response current is measured.

Other characteristic values of the corrosion are also tracked such as the polarization resistance (Rp) and the corrosion current (Icorr).

Further, when the steel sample is in the presence of the solution containing a mixture of neutralized carboxylic acids, a protection plateau is seen to appear in the natural corrosion domain of the material, this protection largely limiting the corrosion current and therefore reducing the overall corrosion speed. This is why the protection plateau as well as the overall speed are elements which are tracked in order to measure the effectiveness of the tested protective composition.

Preparation of the Solutions.

In order to demonstrate the particular advantages of the improved method of the invention, concentrated solutions of a mixture of carboxylic acids are prepared. For this, the acids are mixed in the desired proportions with an aqueous solution containing the neutralization agent TriEthanolAmine (TEA) in a sufficient amount in order to buffer the final solution (pH between 7 and 8). In order to allow better dissolution of fatty acids, the mixture temperature is maintained to at least 30° C. In order to perform the electrochemical tests, the produced mixtures are diluted in corrosive water ASTM D1384 in order to obtain an active material concentration of 10 g/L.

### Comparative Example 1

### Case of the Binary Eutectic HC₁₂/HC₁₆

The present invention aims at showing the anticorrosion effect of dry films obtained by combining two carboxylic acids according to the invention, for protecting metallic surfaces sensitive to atmospheric oxidation. For this, two protective compositions A and B, based on carboxylic acids and on at least one neutralizing agent are prepared, the composition A being that of the prior art, and the composition B being prepared according to the present invention. The total carboxylic acid concentration in the final concentrated solution is 300 g/L for composition A, and 150 g/L for composition B. Their content in weight % is described in Table I hereafter.

TABLE I

| | A | B |
|---|---|---|
| HC₇ | 1.0 | |
| HC₁₁:1 | 0.1 | |
| HC₁₂ | | 1.1 |
| HC₁₆ | | 0.4 |
| HC₁₈ | | |
| Neutralizing agent | NaOH | TEA |
| pH in solution | 7-8 | 7-8 |
| Total concentration | 300 | 150 |
| of carboxylic | | |
| acids (g/L) | | |

Thus, the composition B according to the invention contains the binary eutectic mixture HC₁₂/HC₁₆ in the respective proportions of 72/28% by weight, the melting temperature of which is about 37° C., buffered by excess TEA.

### Electrochemical Results of the Conducted Tests in the Case of the Comparative Example 1

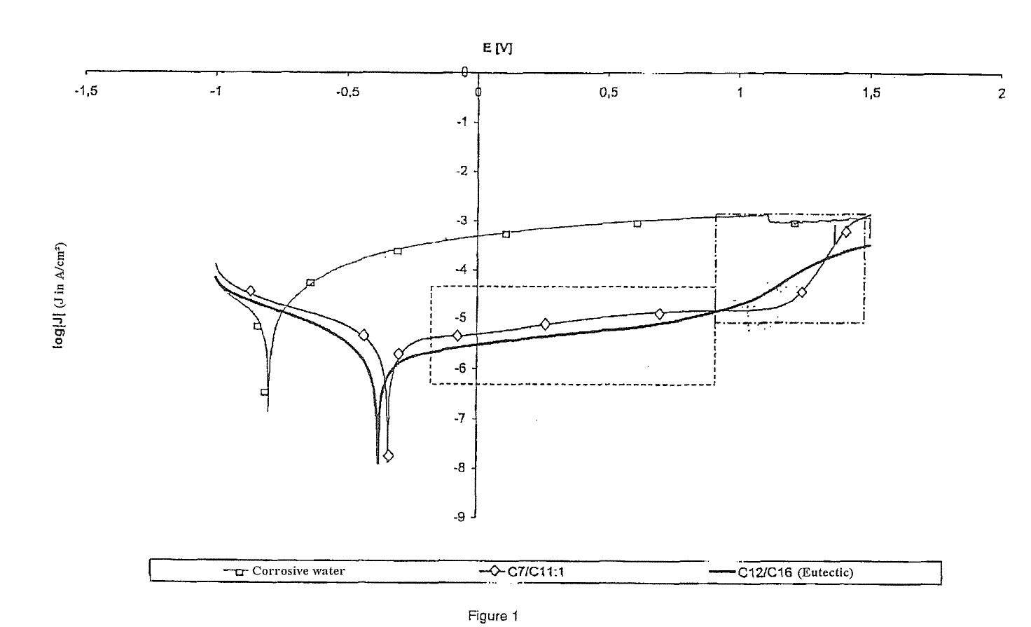

The electrochemical tests, the procedure of which is described hereinbefore, are conducted on corrosive water ASTM D 1384 alone ( [symbol] ) as well as on the solution containing the protective composition A of the prior art (-⋄-), and on the solution containing the protective composition B according to the invention ( [symbol] ). The electrochemical results at 25° C. on carbon steel are plotted in FIG. 1. In this figure, it is seen that by introducing carboxylic acids in solution a protection plateau may be seen in the natural corrosion domain of the material.

It is noted that the intensity of the current flowing through the steel sample in the protection domain, delimited in the following way in FIG. 1, is slightly lower in the case of the steel plate covered with the composition B prepared according to the invention. This means that corrosion is substantially less active and that protection is better. Furthermore, it is seen that the resumption of corrosive activity, schematized in this way in FIG. 1, is milder in the case of the eutectic mixture of the invention B. This is expressed by generalized corrosion which is less detrimental to the metal part.

### Results of the Inhibitory Potential in the Case of the Comparative Example 1

The inhibitory potential of the tested A and B compositions, was moreover determined by measuring polarization resistances (Rp) and corrosion currents (Icorr). The results are grouped in the following Table II.

TABLE II

| | Corrosive | | |
|---|---|---|---|
| | water | C7/C11 | C12/C16 |
| Icorr (A · cm⁻² · 10⁻⁶) | 8.05 | 3.19 | 1.62 |
| Rp (kohm · cm²) | 4.3 | 22.5 | 47.3 |

The obtained results demonstrate the superiority of the composition B prepared according to the invention (55). Indeed, as the resistance to polarization is higher, electron exchanges which are necessary to the corrosion phenomenon, are slowed down. Moreover, the lower corrosion intensity expresses slower corrosion.

### Comparative Example 2

### Case of the Ternary Eutectic HC₁₂/HC₁₆/HC₁₈

The present example aims at showing the anticorrosion effect of dry films obtained by combining three carboxylic acids in eutectic proportions according to the invention, for protecting metallic surfaces sensitive to atmospheric oxidation. For this, a composition C is prepared according to the invention. The total concentration of carboxylic acids in the final concentrated solution is 150 g/L, and its contents appear in Table Ill hereafter.

TABLE III

| | A | B | C |
|---|---|---|---|
| HC₇ | 1.0 | | |
| HC₁₁:1 | 0.1 | | |
| HC₁₂ | | 1.1 | 0.9 |
| HC₁₆ | | 0.4 | 0.4 |
| HC₁₈ | | | 0.3 |
| Neutralizing agent | NaOH | TEA | TEA |
| pH of the solution | 7-8 | 7-8 | 7-8 |
| Total concentration | 300 | 150 | 150 |
| of carboxylic | | | |
| acids (g/L) | | | |

The composition C according to the invention contains the ternary eutectic mixture HC₁₂/HC₁₆/HC₁₈ in the respective proportions of 57/23/20% by weight, the melting point of which is about 33.5° C.

### Results of the Conducted Electrochemical Tests in the Case of Comparative Example 2

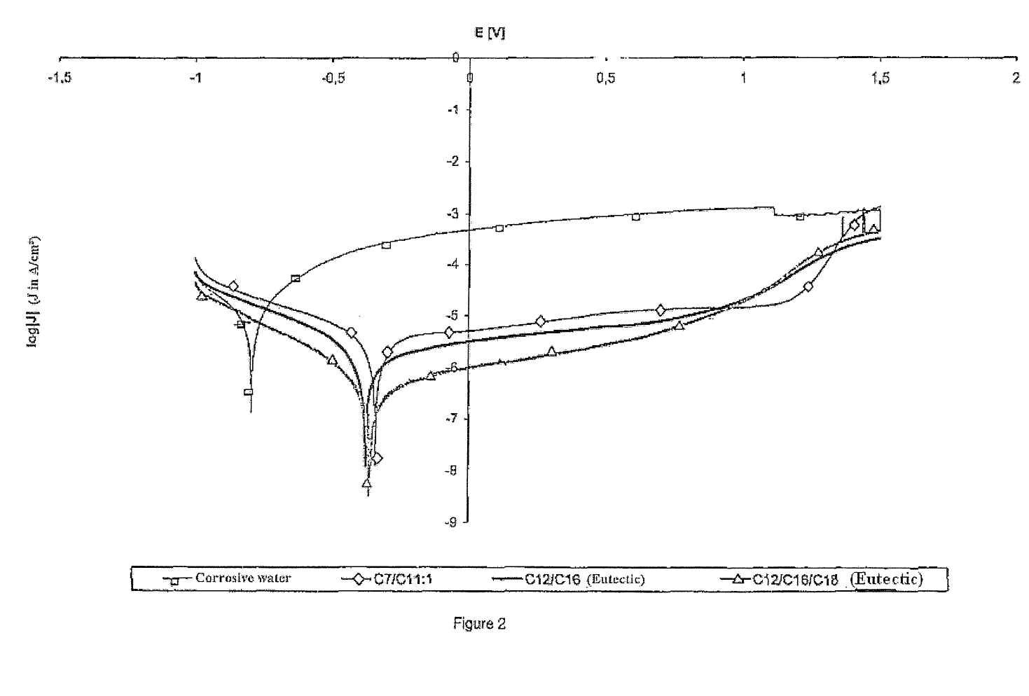

The electrochemical tests, the procedure of which is described above, are conducted as earlier, on corrosive water ASTM D1384 alone (^{-u-}) as well as on the solution containing the protective composition A of the prior art (-⋄-), and the solution containing the protective composition B according to the invention (==), in addition to the solution containing the protective composition C according to the invention (-Δ-). The electrochemical results at 25° C. on carbon steel are reported in FIG. 2. On this figure, the appearance of a protection plateau is also observed in the natural corrosion domain of the material by using carboxylic acids.

It is also seen that the behavior of the ternary eutectic mixture HC₁₂/HC₁₆/HC₁₈ is quite similar to that of the HC₁₂/HC₁₆ mixture. However, the performances of the ternary eutectic composition C are superior, because the position of the curve relative to the composition C is located below that of the binary eutectic composition B in a wide domain. Thus, when the current flowing through the sample is lower, corrosion is less strong.

### Inhibitory Potential Results in the Case of Comparative Example 2

Further, the values of the characteristic parameters Rp and Icorr are grouped in Table IV, tend to confirm this assessment.

TABLE IV

| | Corrosive | | | |
|---|---|---|---|---|
| | water | C₇/C₁₁ | C₁₂/C₁₆ | C₁₂/C₁₆/C₁₈ |
| Icorr (A · cm⁻² · 10⁻⁶) | 8.05 | 3.19 | 1.62 | 0.42 |
| Rp (kohm · cm²) | 4.3 | 22.5 | 47.3 | 182.1 |

### Comparative Example 3

### Case of the Ternary Eutectic HC₁₂/HC₁₆/HC_{22:0}

The total concentration of carboxylic acids in the final concentrated solution is 150 g/L, and its contents appear in Table V hereinbelow.

TABLE V

| | A | B | C |
|---|---|---|---|
| HC₇ | 1.0 | | |
| HC₁₁:1 | 0.1 | | |
| HC₁₂ | | 1.1 | 0.6 |
| HC₁₆ | | 0.4 | 0.2 |
| HC20:0 | | | 0.2 |
| Neutralizing agent | NaOH | TEA | TEA |
| pH into the solution | 7-8 | 7-8 | 7-8 |
| Total concentration | 300 | 150 | 150 |
| of carboxylic | | | |
| acids (g/L) | | | |

The composition D, according to the invention, contains the ternary eutectic mixture HC₁₂/HC₁₆/HC_{22.0} in the proportions of 57.5/22.5/20% by weight respectively, the melting point of which is about 34.5° C. The mixture is neutralized by TEA so as to attain a pH in the diluted solution of the order of 7-8. This composition is compared with composition B according to the invention and with composition A according to the prior art.

### Results of the Conducted Electrochemical Tests in the Case of Comparative Example 3

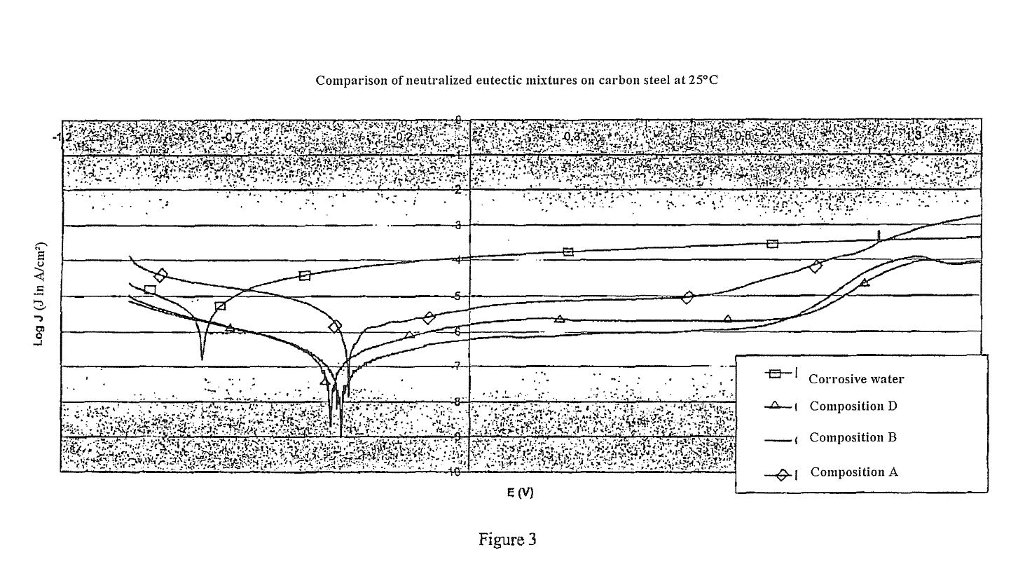

The electrochemical tests, the procedure of which is described above, are conducted, as earlier, on corrosive water ASTM D1384 alone (^{-u-}) as well as on the solution containing the protective composition A of the prior art (-⋄-), and the solution containing the protective composition B according to the invention (==), in addition to the solution containing the protective composition D according to the invention (-Δ-). The electrochemical results at 25° C. on carbon steel are reported in FIG. 3.

It is seen that in the present case, the HC₁₂/HC₁₆ and HC₁₂/HC₁₆/HC_{22.0} compositions provide better protection than in the case of protection provided by the composition according to the prior art. However, the ternary eutectic composition D seems to provide slightly lower protection than that of the binary eutectic composition C on this support. Both curves remain after all quite close, this difference seems to be relatively insignificant.

### Inhibitory Potential Results in the Case of Comparative Example 3

Further, the values of the characteristic parameters Rp and Icorr grouped in Table IV, tend to confirm this assessment. The difference between the binary and ternary eutectic compositions shown in this example is much greater if interest is focused on the characteristic parameters. It is then seen that the protective film formed on carbon steel by the ternary eutectic composition D has strong resistance to polarization and a low corrosion current, which means that the electron exchanges through the protective film are difficult and that corrosion is strongly reduced.

TABLE VI

| | Corrosive | | | |
|---|---|---|---|---|
| | water | C₇/C₁₁ | C₁₂/C₁₆ | C₁₂/C₁₆/C_{22:0} |
| Icorr (A · cm⁻² · 10⁻⁶) | 8.05 | 3.19 | 1.62 | 0.33 |
| Rp (kohm · cm²) | 4.3 | 22.5 | 47.3 | 243.8 |

### Comparative Example 4

### Case of the Ternary Eutectic HC₁₂/HC₁₆/HC_{22:1}

The total concentration of carboxylic acids in the final concentrated solution is 150 g/L, and its contents appear in Table VII hereinbelow.

TABLE VII

| | A | B | E | F |
|---|---|---|---|---|
| HC₇ | 1.0 | | | |
| HC₁₁:1 | 0.1 | | | |
| HC₁₂ | | 1.1 | 0.3 | 0.2 |
| HC₁₆ | | 0.4 | 0.2 | 0.1 |
| HC_{22:1} | | | 0.7 | 0.5 |
| Neutralizing agent | NaOH | TEA | TEA | TEA/DGA |
| pH of the solution | 7-8 | 7-8 | 7-8 | 8-9 |
| Total concentration | 300 | 150 | 150 | 150 |
| of carboxylic | | | | |
| acids (g/L) | | | | |

The E and F compositions according to the invention contain the ternary eutectic mixture HC₁₂/HC₁₆/HC_{22:1} in the respective proportions of 28.5/11.5/60% by weight, the melting point of which is about 13.5° C. Mixture E is neutralized by TEA so as to attain a pH in the diluted solution of the order of 7-8. Mixture F is neutralized by a TEA/DGA mixture (in proportions of ⅔, ⅓) so as to attain a pH in the diluted solution of the order of 8-9. These compositions are compared to the composition B according to the invention and to the composition A of the prior art. The electrochemical tests, the procedure of which is described above, are conducted as earlier on corrosive water ASTM D1384 alone ( [symbol] ) as well as on the solution containing the protective composition A of the prior art (-⋄-), and on the solution containing the protective composition B according to the invention ( [symbol] ), in addition to the solution containing the protective composition E according to the invention (-Δ-) and the solution containing the protective composition F according to the invention ( [symbol] ).

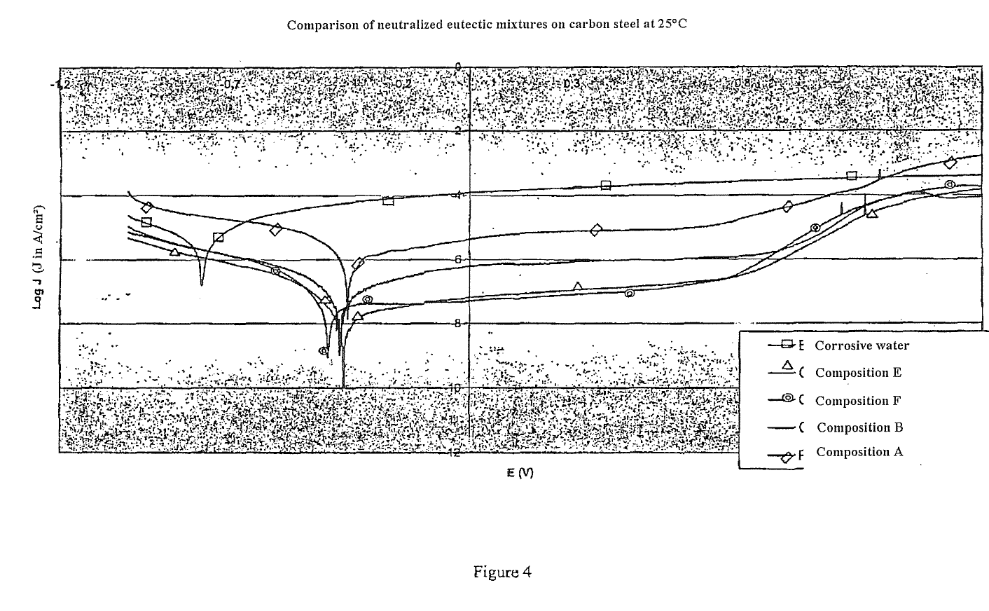

The electrochemical results at 25° C. on carbon steel are reported in FIG. 4. It is seen that both compositions containing erucic acid (HC_{22:1}) provide better protection on carbon steel comparatively to the binary eutectic composition according to the invention. This is expressed by the fact that these curves are placed below that of the binary eutectic composition according to the invention.

### Inhibitory Potential Results in the Case of Comparative Example 4

Moreover, the values of the characteristic parameters Rp and Icorr grouped in Table VIII, tend to confirm this assessment.

TABLE VIII

| | Corro- | | | C₁₂/C₁₆/ | C₁₂/C₁₆/ |
|---|---|---|---|---|---|
| | sive | | | C_{22:1} | C_{22:1} |
| | water | C₇/C₁₁ | C₁₂/C₁₆ | (TEA) | (TEA/DGA) |
| Icorr | 8.05 | 3.19 | 1.62 | 2.30 | 3.15 |
| (A · cm⁻²· 10⁻⁶) | | | | | |
| Rp | 4.3 | 22.5 | 47.3 | 1338 | 995.2 |
| (kohm · cm²) | | | | | |

It is seen here that the protective films formed by both ternary eutectic compositions according to the invention have a very large resistance to polarization. Electron exchanges related to corrosion are therefore very difficult through the film. The corrosion current remains low, even though it is slightly greater to that in the case of the binary eutectic composition.

### Comparative Example 5

### Case of the Ternary Eutectic C₁₂/C₁₆/C_{22:1} on Galvanized Steel

In addition to the results obtained on carbon steel, other tests were conducted on galvanized steel (deposition of a zinc/aluminium layer on carbon steel). The protective composition A according to the prior art provides very good resistance to corrosion under industrial conditions. The electrochemical results on this support will therefore also be compared, according to the same experimental procedure for composition A according to the prior art and composition F according to the invention.

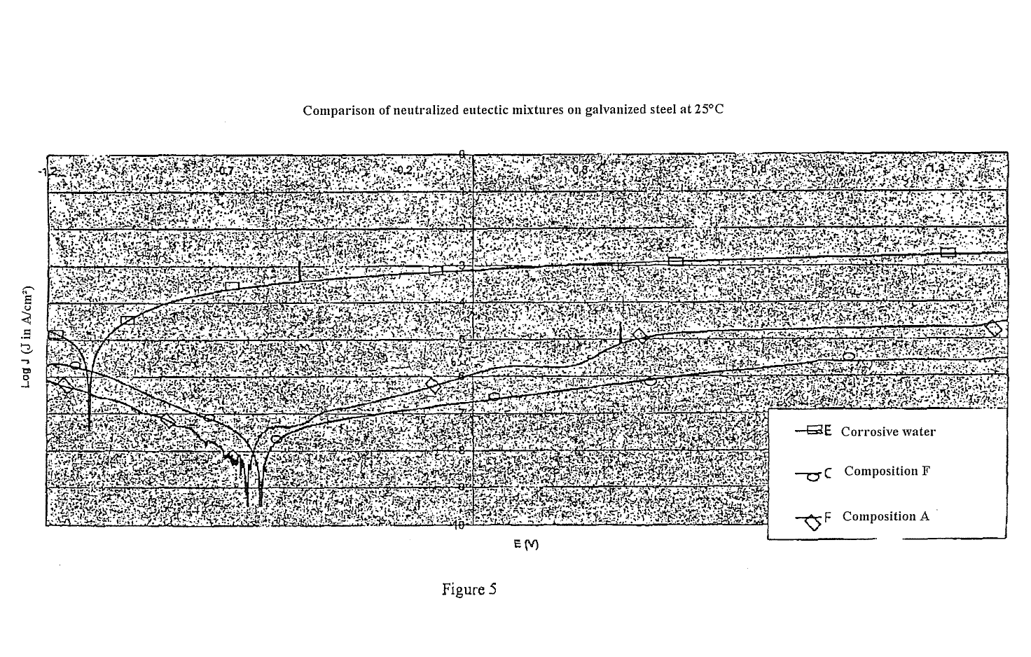

In FIG. 5, it is seen that the curve corresponding to composition F is placed below that of the composition according to the prior art. This means that the protection provided by the anticorrosion solution according to composition F is better than with the solution according to the prior art A.

1.-31. (canceled)

32. A composition based on carboxylic acids and on at least one neutralizing agent, wherein the composition comprises a eutectic mixture of at least two carboxylic acids comprising n carbon atoms, with 6≦n≦22, and a neutralizing agent.

33. The composition according to claim 32, wherein n is even.

34. The composition according to claim 32, wherein n≧10.

35. The composition according to claim 32, wherein n is ≦18.

36. The composition according to claim 32, wherein the eutectic mixture is a mixture of two carboxylic acids.

37. The composition according to claim 36, wherein:
n is from 10 to 16 for the first carboxylic acid; and
n is from 14 to 22 for the second carboxylic acid.

38. The composition according to claim 36, wherein the difference between each value of n for each of both acids ranges from 2 to 10.

39. The composition according to claim 36, wherein the respective mass proportions of said acids are x±5%-y±5%, x and y being the respective mass proportions of both acids in said eutectic mixture with the exact composition of the eutectic.

40. The composition according to claim 32, wherein the eutectic mixture is a mixture of three carboxylic acids.

41. The composition according to claim 40, wherein:
n is from 10 to 16 for the first carboxylic acid;
n is from 14 to 18 for the second carboxylic acid; and
n is from 16 to 22 for the third carboxylic acid.

42. The composition according to claim 40, wherein the respective proportions of said acids are x±3%-y±3%-z±3% for a ternary mixture, x, y and z, being the respective mass proportions of the three acids in the mixture with the exact composition of the eutectic.

43. The composition according to claim 32, further comprising from 0.5 to 5% by weight of at least one anticorrosion agent selected from triazole derivatives, derivatives of imidazole, derivatives of citric acid, derivatives of sorbic acid, and mixtures thereof.

44. The composition according to claim 32, wherein the acid is selected from capric acid, lauric acid, myristic acid, palmitic acid, stearic acid, arachidic acid, behenic acid, palmitoleic acid, oleic acid, gadoleic acid, erucic acid, heptanoic acid, nonanoic acid, and undecylenic acid, and mixtures thereof.

45. The composition according to claim 32, wherein the neutralizing agent is selected from sodium hydroxide, potassium hydroxide, primary, secondary or tertiary amines, and mixtures thereof.

46. The composition according to claim 32, further comprising a surfactant, a dispersant, or a mixture thereof.

47. The composition according to claim 46, wherein said surfactant is selected from alkylpolyglycosides, ethoxylated fatty alcohols, ethoxylated fatty acids, ethoxylated oils, ethoxylated sorbitan esters, and mixtures thereof.

48. The composition according to claim 46, wherein said dispersant is selected from polyols with high molecular weight, salts of carboxylic acids such as (meth)acrylic copolymers, derivatives of polyamides such as waxes of polyamides, and mixtures thereof.

49. The composition according to claim 32, further comprising water as a sole solvent.

50. The composition according to claim 32, wherein the pH is from 6 to 9.

51. The composition according to claim 32, wherein at least one of the acids is of vegetable origin.

52. The composition according to claim 32, wherein the concentration of acids is from 1 to 500 g/L of active material, expressed as the total of carboxylic acid.

53. A method for making a composition according to claim 32, by mixing its constituents with heating.

54. (canceled)

55. The method according to claim 68, wherein the metallic surface comprises a metal selected from zinc, iron, aluminum, copper, lead, alloys thereof, and mixtures thereof.

56. The method according to claim 68, wherein applying said composition is carried out by sprinkling, spraying, or immersion.

57. (canceled)

58. A metallic object according to claim 69, whereof the metallic surface is covered with a dry film comprising said composition.

59. A method for washing objects according to claim 58 with water.

60. (canceled)

61. A method for painting or varnishing an object according to claim 66.

62. A dry film comprising the composition according to claim 32.

63. A composition according to claim 43, wherein the anticorrosion agent comprises benzotriazole, tolyl triazole, or benzimidazole.

64. The composition according to claim 50, wherein the pH is from 7 to 9.

65. The composition according to claim 50, wherein the pH is from 7 to 8.

66. The composition according to claim 52, wherein the concentration of acids is from 100 to 500 g/L of active material.

67. The composition according to claim 52, wherein the concentration of acids is from 1 to 50 g/L of active material.

68. A method for treating metallic objects having a metallic surface comprising applying to the surface a composition comprising a eutectic mixture of at least two carboxylic acids comprising n carbon atoms, with 6≦n≦22, and a neutralizing agent.

69. A metallic object having a surface, wherein the surface is covered with a composition comprising a eutectic mixture of at least two carboxylic acids comprising n carbon atoms, with 6≦n≦22.
